(19) United States
(12) Patent Application Publication
(10) Pub. No.: US 2016/0047699 A1
(43) Pub. Date: Feb. 18, 2016

(54) Sensorelement, Thermometer sowie Verfahren zur Bestimmung einer Temperatur

(71) Applicant: ENDRESS+HAUSER WETZER GMBH+CO. KG, Nasselwang (DE)

(72) Inventor: Peter Seefeld, Pfronten (DE)

(21) Appl. No.: 14/652,941

(22) PCT Filed: Dec. 6, 2013
(86) PCT No.: PCT/EP2013/075791

§ 371 Date: Oct. 7, 2015

(30) Foreign Application Priority Data
Dec. 18, 2012 (DE) 10 2012 112 575.9

(51) Int. Cl. G01K 15/00; G01K 7/34; G01K 11/00

(52) U.S. Cl. CPC G01K 15/005; G01K 11/00; G01K 7/34

(57) ABSTRACT

A sensor element comprising a measuring path, which is isolated by a dielectric from a reference element, which is composed of a material, which at a predetermined temperature experiences a phase transition, which changes the electrical conductivity of the material.

The invention relates to a sensor element, a thermometer, the use of the sensor element, as well as to a method for determining a predetermined temperature.

Such sensor elements, which are used, for example, for registering a temperature and are composed, for example, of a temperature dependent resistance, are known to be applied in a plurality of applications, especially in process automation technology.

Thus, for example, known from patent application DE 2251969 A is an apparatus for holding temperature constant, wherein a transistor as a heating element and a diode with temperature dependent properties resulting from a substance with an anormal jump in electrical conductivity are provided.

Known, furthermore, from Offenlegungsschrift DE 2300199 A is a powdered substance composed of resistive oxides.

Known from Offenlegungsschrift DE 2424468 A is a temperature compensated, thermorelay system, in the case of which an abrupt impedance change occurs at a predetermined transition temperature.

Known from patent DE 2436911 B, furthermore, is a method for manufacture of thin-film hot conductor elements based on vanadium oxide, in the case of which there is applied on a suitable substrate a thin layer, which is composed predominantly of a vanadium oxide material, wherein the vanadium oxide material is, furthermore, doped with foreign atoms.

In principle, it is in temperature measurement difficult to assure that the temperature measurement is reliable, and contains, for example, no aging related, drift effects. Additionally, it is a well-known problem in temperature measurement to validate, adjust, calibrate, standardize and/or certify the measuring transducer, the so-called temperature sensor element. Especially in process automation technology, such sensor elements, such as, for example, those in thermometers or, generally, in apparatuses for determining a temperature, are often integrated into the process in such a manner that their removal is often only possible with significant effort or requires special apparatuses, such as, for example, installation assemblies suitable for this purpose. For example, Offenlegungsschrift DE 102010040039 A1 is concerned with the problems arising in adjusting, calibrating or certifying thermometers.

Starting from these problems known from the state of the art, it is an object of the present invention to enable long term stable calibrating, validation, adjusting and/or certification in an especially simple, especially compact manner.

The object is achieved according to the invention by a sensor element, a thermometer with a sensor element, the use of the sensor element as well as a method for determining a predetermined temperature.

As regards the sensor element, the object is achieved by a sensor element comprising a measuring path, which is isolated by a dielectric from a reference element, which is composed of a material, which at a predetermined temperature experiences a phase transition, which changes the electrical conductivity of the material.

By changing the chemical and physical properties of the material, of which the reference element is at least partially composed, via the interaction of the reference element with the measuring path, the phase transition of the material, of which the reference element is composed, can be ascertained. In this way, there arises a comparison value, which at a predetermined and, thus, known temperature brings about a changing physical and/or chemical property of the material of the reference element, in order to validate, calibrate, adjust and/or certify a measurement signal, which is registered by means of the first measuring path.

In a form of embodiment of the sensor element, the sensor element is arranged in such a manner relative to the measuring path that in the case of a phase transition of the reference element the reference element capacitively couples with the measuring path, respectively with a part of the measuring path. For example, in the course of the phase transition, the electrical properties of the material, of which the reference element is composed, can change. Preferably, the material is selected in such a manner that with a phase transition of the reference element a change of the electrical conductivity of the reference element occurs. By a corresponding arrangement of the reference element, via a capacitive in-coupling of the reference element relative to the measuring path, a change of a measuring signal, with which the measuring path is supplied, can be ascertained as a function of present phase of the reference element. In this way, the temperature present in the immediate vicinity of the sensor element can be deduced.

In an additional form of embodiment of the sensor element, the measuring path has at least sectionally a meander shaped course. This meander shaped course provides an especially large contact surface of the measuring path on the dielectric, on which the measuring path is preferably applied.

In an additional form of embodiment of the sensor element, the measuring path is composed of a metal material, preferably platinum.

In an additional form of embodiment of the sensor element, the measuring path and the reference element are arranged on the same substrate. For example, the substrate can have a front- and a rear-side, wherein the reference element is arranged on the rear-side and the measuring path on the front side of the substrate.

In an additional form of embodiment of the sensor element, a layer isolating the measuring path from the reference element serves as dielectric. The dielectric is preferably the substrate, on which the measuring path and preferably also the reference element are applied.

In an additional form of embodiment of the sensor element, the material of the reference element is composed of a transition metal, preferably vanadium or a vanadium oxide, respectively a transition metal containing material, preferably a vanadium- or a vanadium oxide containing material.

In an additional form of embodiment of the sensor element, the measuring path, the dielectric and/or the reference element are/is a thin film, respectively a thick film. Preferably, in such case, especially the measuring path and the reference element are embodied as thin film layers.

In an additional form of embodiment of the sensor element, the phase transition changes the electrical resistance of the sensor element.

In an additional form of embodiment of the sensor element, the reference element transfers with the phase transition from a state with a first electrical conductivity into a state with a second electrical conductivity.

In an additional form of embodiment of the sensor element, the reference element transfers with the phase transition from a state, in which the reference element is essentially an electrical insulator, into an electrically conductive state.

In an additional form of embodiment of the sensor element, a supplying of the measuring path with a measuring signal, preferably an impedance measurement, serves to determine the phase state of the reference element.

To this end, for example, one or more signal taps can be provided, by which the measuring path is defined on a thin film segment. By impedance measurement, then for the measuring path, respectively for the sensor element, the associated capacitance can be ascertained, which has different values as a function of the existing phase of the reference element.

In an additional form of embodiment of the sensor element, based on the measuring path supplied with the measuring signal, a temperature, respectively the reaching of a temperature, preferably the predetermined temperature, at which the material, of which the reference element is composed, experiences a phase transition, is determined. For example, in the case of a phase transition of the reference element, a characteristic, especially step shaped, waveform of the measurement signal can occur.

In an additional form of embodiment of the sensor element, the reference element is composed of a number of sections having different phase transformation temperatures, preferably of material having different doping, wherein the sections are especially preferably isolated from one another. Especially, a multi stage curve of the impedance, respectively the capacitance, or, generally, a measuring signal, with which the measuring path is supplied, can be obtained thereby.

In an additional form of embodiment of the sensor element, the sections of the sensor element are connected electrically conductively in parallel with one another.

In an additional form of embodiment of the sensor element, the sections have different strengths, thicknesses and/or dopings. Through such measures, the transition temperature, at which a phase transition of the material takes place, can be influenced.

In an additional form of embodiment of the sensor element, the sections of the reference element are arranged in layers on top of one another.

In an additional form of embodiment of the sensor element, the sections of the reference element are arranged next to one another preferably essentially in one plane.

As regards the thermometer, the object is achieved by a thermometer having a sensor element according to one of the preceding forms of embodiment.

As regards the use of the sensor element, the object is achieved by the use of the sensor element for adjusting, validating, calibrating and/or certifying a thermometer.

As regards the method, the object is achieved by a method for determining a predetermined temperature, wherein a measuring signal is supplied to a measuring path, which a dielectric isolates from a reference element, which experiences a phase transition at the predetermined temperature, wherein a measurement signal is compared with a comparison value, in order to ascertain the phase of the reference element. Based on the ascertained phase, thus, also the present temperature can be deduced and this compared temperature value determined with the measurement signal.

In a form of embodiment of the method, an impedance measurement is performed by means of the measuring signal and an impedance value ascertained, which is compared with a comparison value. The impedance measurement occurs, in such case, by supplying the measuring path with the measuring signal.

The measuring path and the reference element can thus, in the case in which the reference element is located in an electrically conductive state, act as a capacitor, which capacitor performs, for example, the function of a band pass filter, so that only certain measurement signals, respectively measurement signals with a certain frequency fraction, are transmitted unfiltered via the measuring path. Based on the phase transition, respectively the arising phase transitions, of the reference element, respectively of the material, of which the reference element is composed, thus, a characteristic, especially step shaped, capacitance curve of the sensor element, respectively the measuring path, can be ascertained.

Thus, a sensor element is provided preferably for temperature measurement, which can be used especially in apparatuses of process automation technology, such as, for example, a measuring insert. Such apparatuses use, for example, a protective tube, in which the measuring insert can be inserted, in order to register the temperature of a measured material. The sensor element includes for this purpose, for example, at least one, or preferably a number of, thin film segments. A first of these thin film segments can be, for example, a meander shaped platinum thin film, which is applied on a dielectric substrate, which is composed, for example, of an aluminum oxide containing ceramic. Via this substrate acting as dielectric, the metal thin film, which serves as measuring path, can capacitively couple with a further thin film segment, which is composed, for example, of a doped or undoped vanadium oxide. The vanadium oxide containing thin film segment is, in such case, isolated through a dielectric intermediate layer from the meander shaped platinum thin film segment, which, for example, is applied on the same substrate. Via this intermediate layer, there occurs a capacitive coupling between the thin film segment serving as reference element and the measuring path. Vanadium oxide experiences at a temperature of around 60° C. a semiconductor to metal transition, i.e., a phase transformation. This phase transformation leads to a resistance change of the vanadium oxide. This is utilized according to the invention, in order to determine, due to a capacitive coupling resulting between the reference element and the measuring path, an impedance value, which functions as reference variable. The resistance measurement of the temperature dependent, resistance element, for example, in the form of a thin film layer, respectively a thin film segment, can, in such case, occur at the same time as the impedance measurement of the measuring path.

For example, the measuring path, respectively the reference element, can be applied in the form of a thin film, respectively, on a front side of the substrate and on a rear-side of the substrate lying opposite the front side. In such case, for example, planar etching or a planar recessing, performed by ablation, can be provided, in order to arrange, next to one another and contacted edgewise, a number vanadium oxide layers of different doping connected in parallel.

The reference element can also be composed of a number of, for example, step shaped superimposed, i.e. arranged on top of one another, vanadium oxide layers, for example, of different dopings. The doping serves to reduce or to increase the phase transformation temperature of the reference element. A change of the phase transformation temperature can also occur by an adapting of the thickness or width of the layers. For example, a stepped impedance change of the measuring path, respectively of the total capacitive measuring arrangement, can occur in this way.

Furthermore, the substrate can also be coated only unilaterally. For example, a meander-shaped metal structure, which forms the first measuring path, can be coated with a dielectric cover layer of 0.2 to 3 μm. On this cover layer can be arranged, in turn, a number of mutually superimposed, at least partially overlapping, layers of a reference material, for example, vanadium oxide having different dopings. Measuring path and reference element thus form a capacitor.

The invention will now be explained in greater detail based on the appended drawing, the figures of which show as follows:

FIG. 1 a schematic representation of a first form of embodiment of the proposed invention, in a plan view,

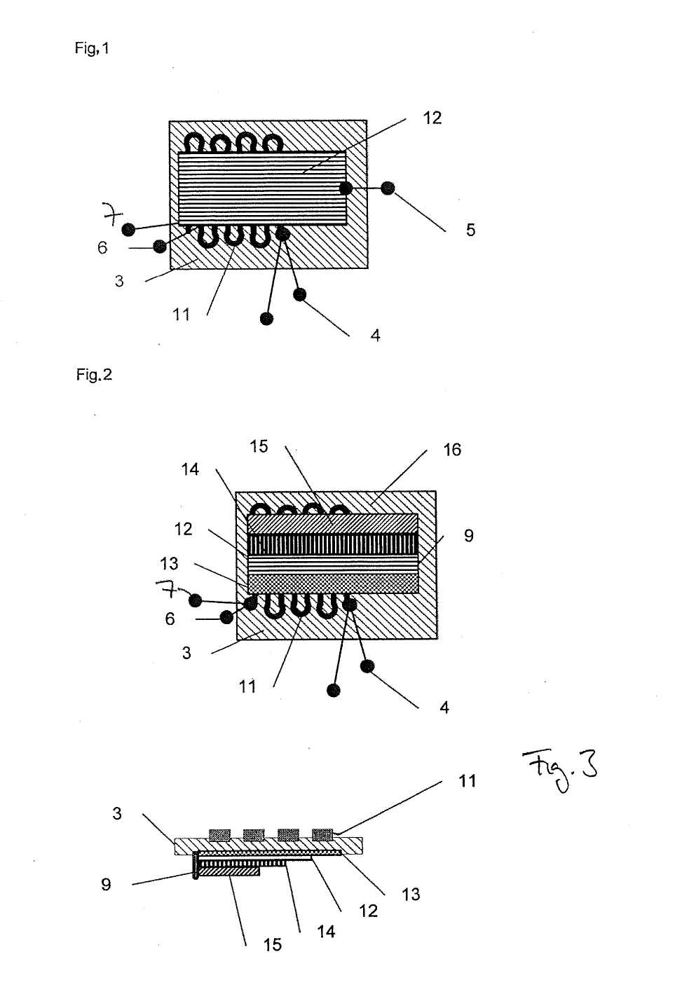

FIG. 2 a schematic representation of a second form of embodiment of the proposed invention, likewise in a plan view,

FIG. 3 a schematic representation of a third form of embodiment of the proposed invention, in a cross section,

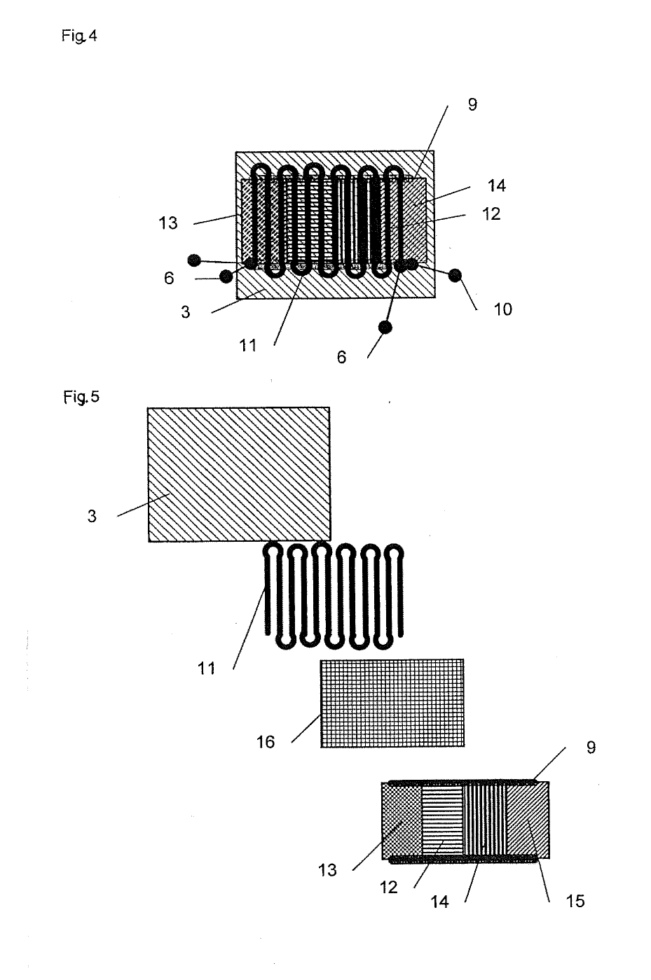

FIG. 4 a schematic representation of a fourth form of embodiment of the proposed invention, in a plan view, and

FIG. 5 a schematic representation of a fifth form of embodiment of the proposed invention, in an exploded view.

FIG. 1 shows a substrate 3, i.e. a carrier, on which a measuring path 11 in the form of a meandering metal wire is applied. Applied on the wire is a cover layer 16, which serves as dielectric and separates the measuring path 11 from a reference material 12 applied on the cover layer 16.

The measuring path 11 is provided with taps 4 and 6, which serve for tapping a measurement signal from the measuring path 11, respectively loading the measuring path 11 with a measuring signal. Furthermore, there is provided on the reference element 12 a tap 5, via which the capacitance of the capacitor composed of the measuring path 11 and the reference element 12 can be determined.

Due to the fact that the reference element 12, respectively the material, of which the reference element is composed, experiences a phase transition at a temperature range relevant for calibrating, validation, adjusting or certification, where an electrical property, such as, for example, the electrical conductivity of the reference element 12, changes, the reaching of the phase transformation temperature can be ascertained based on determining the capacitance between the measuring path and the reference element 12.

Instead of the cover layer, also the substrate 3 can serve as a dielectric and, for example, the measuring path 11 can be arranged on a side of the substrate 3 lying opposite the reference element 12.

FIG. 2 shows a form of embodiment of the proposed invention, wherein, instead of one, a number of reference elements are provided, which have different phase transformation temperatures, respectively a reference element is provided, which is composed of sections (12, 13, 14, 15), which have different phase transformation temperatures.

The sections (12, 13, 14, 15) can be, for example, vanadium oxide layers having different dopings.

The vanadium oxide layers can be electrically contacted, for example, via a trace-like tap 9 (together), preferably edgewise, i.e. extending along edges of the layers, respectively sections, 12, 13, 14, 15. Furthermore, the layers can be contacted individually via dot-like, electrical contacts.

Thus, the capacitance of the sensor element formed of reference element 12 and measuring path 11 can be determined. Since the different sections 12, 13, 14, 15, respectively layers, have different transition temperatures, there results also a stepped capacitance curve in the case of moving through the respective phase transformation temperatures of the different sections 12, 13, 14, 15.

FIG. 3 shows a form of embodiment of the proposed invention, in the case of which the measuring path 11 is arranged on one side of the substrate 3, the front side, and a number of mutually superimposed layers 12, 13, 14, 15 of materials having different phase transformation temperatures are arranged on the side lying opposite the front side, i.e. the rear-side, wherein the electrical properties of the materials depend on the phase, in which the particular reference material 12, 13, 14, 15 is located.

The layers 12, 13, 14, 15 are, in such case, electrically connected together at their edges via a trace-like tap 9. In the case of phase transition in going from low to high temperature, for example, the conductivity of the respective layer 12, 13, 14, 15 rises, whereupon also the capacitance of the capacitor formed of measuring path 11 and reference element 12 rises in steps, or stages.

FIG. 4 shows a form of embodiment, in the case of which, on a substrate 3 same as in FIG. 1, a measuring path of a metal material is applied and covered by a cover layer 16.

Furthermore, a reference element, which is composed of a number of mutually adjoining sections 12, 13, 14, 15, is applied on the cover layer, respectively the substrate.

The sections 12, 13, 14, 15 of the reference element are electrically connected with one another edgewise by a first conductive, trace-like, and a second conductive, trace-like, tap 9, 10. However, another option is to connect only a part of these sections electrically with one another, while another part contains, for example, one or more sections, which are electrically insulated from one another.

It is, thus, possible to determine the phase present in one or more of the sections of the reference element 12, 13, 14, 15 and, thus, a reference temperature, for example, a temperature range or a phase transformation temperature, on the one hand, by a signal tapping between the first and second trace-like taps 9, 10 and, on the other hand, between one of the trace-like taps 9, 10 and the measuring path 11.

FIG. 5 shows an exploded view of a form of embodiment of the proposed invention.

Applied on a substrate 3 can be a measuring path 11, which, in turn, is covered by a cover layer 16. The cover layer 16 serves, in such case, as dielectric.

Applied on the cover layer 16 can be a reference element, which is composed of a number of edge-contacted sections 12, 13, 14, 15, which have preferably different phase transformation temperatures.

In general, the measuring path 11 is preferably a temperature dependent resistor, such as is currently often applied for determining temperature, for example, of a measured material in a container. Such measuring paths currently utilize, for example, a thin film layer.

The reference element 12 can, thus, be used for in-situ calibrating of the temperature dependent resistance, i.e. without having to remove a corresponding measuring device from a container and without, in given cases, having to interrupt the process running in the container.

### LIST OF REFERENCE CHARACTERS

11 measuring path
3 substrate
4 first tap
6 second tap
5 third tap
7 fourth tap
9 conductive trace-like contact
12 section with a first phase transformation temperature
13 section with a second phase transformation temperature
14 section with a third phase transformation temperature
15 section with a fourth phase transformation temperature
16 cover layer

1-22. (canceled)

23. A sensor element comprising:
a dialetric;
a reference element;
a measuring path, which is isolated by said dielectric from said reference element, which is composed of a material, which at a predetermined temperature experiences a phase transition, which changes the electrical conductivity of the material.

24. The sensor element as claimed in claim 23, wherein:
said reference element is arranged in such a manner relative to said measuring path that in the case of a phase transition of said reference element said reference element capacitively couples with said measuring path, respectively a part of said measuring path.

25. The sensor element as claimed in claim 24, wherein:
said measuring path has, at least sectionally, a meander-shaped course.

26. The sensor element as claimed in claim 25, wherein:
said measuring path is composed of a metal material, preferably platinum.

27. The sensor element as claimed in claim 26, further comprising:
a substrate, wherein said measuring path and said reference element are arranged on said same substrate.

28. The sensor element as claimed in claim 27, further comprising:
a layer isolating said measuring path from said reference element and serves as said dielectric.

29. The sensor element as claimed in claim 28, wherein:
the material is composed of a transition metal, preferably vanadium or a vanadium oxide, respectively a transition metal containing material, preferably a vanadium or a vanadium oxide containing material.

30. The sensor element as claimed in claim 29, wherein:
said measuring path, said dielectric and/or said reference element are/is a thin film, respectively thick film.

31. The sensor element as claimed in claim 30, wherein:
the phase transition changes the electrical resistance and/or the electrical conductivity of said reference element.

32. The sensor element as claimed in claim 23, wherein:
said reference element transfers with the phase transition from a state with a first electrical conductivity into a state with a second electrical conductivity.

33. The sensor element as claimed in claim 23, wherein:
said reference element transfers with the phase transition from a state, in which said reference element is essentially an electrical insulator, into an electrically conductive state.

34. The sensor element as claimed in claim 33, wherein:
supplying said measuring path with a measuring signal, preferably an impedance measurement, serves to determine the phase state of said reference element.

35. The sensor element as claimed in claim 34, wherein:
based on said measuring path supplied with said measuring signal, a temperature, respectively the reaching of a temperature, preferably the predetermined temperature, at which the material, of which said reference element is composed, experiences a phase transition, is determined.

36. The sensor element as claimed in claim 35, wherein:
said reference element is composed of a number of sections having different phase transformation temperatures, preferably of material having different doping, said sections being especially preferably isolated from one another and/or are connected with one another via conductive trace-like taps.

37. The sensor element as claimed in claim 36, wherein:
said sections are electrically connected in parallel with one another.

38. The sensor element as claimed in claim 37, wherein:
said sections have different strengths, thicknesses and/or dopings.

39. The sensor element as claimed in claim 38, wherein:
said sections of said reference element are arranged in layers on top of one another.

40. The sensor element as claimed in claim 39, wherein:
sections of said reference element are arranged next to one another, preferably essentially in one plane.

41. A thermometer having a sensor element, comprising:
a dialetric; a reference element; a measuring path, which is isolated by said dielectric from said reference element, which is composed of a material, which at a predetermined temperature experiences a phase transition, which changes the electrical conductivity of the material.

42. Use of a sensor element comprising: a dialetric; a reference element; a measuring path, which is isolated by said dielectric from said reference element, which is composed of a material, which at a predetermined temperature experiences a phase transition, which changes the electrical conductivity of the material for validating, adjusting, calibrating and/or certifying a thermometer.

43. A method for determining a predetermined temperature, comprising the steps of:
supplying a measuring signal to a measuring path, which a dielectric isolates from a reference element; which experiences a phase transition at the predetermined temperature; and
comparing a measurement signal with a comparison value, in order to ascertain the phase of the reference element.

44. A method as claimed in claim 43, further comprising the step of:
performing an impedance measurement by means of the measuring signal and an impedance value is ascertained, which is compared with a comparison value.
